(19) United States
(12) Patent Application Publication
(10) Pub. No.: US 2003/0086778 A1
(43) Pub. Date: May 8, 2003

(54) Apparatus for loading cargo into vehicles

(76) Inventor: Robert L. Smith, Plant City, FL (US)

Correspondence Address: WILLIAMS. VAN ROYEN, PETTIS & VAN ROYEN, P.A., Suite 700, 501 E. Kennedy Boulevard, Tampa, FL, 33602, US

(21) Appl. No.: 10/053,142

(22) Filed: Nov. 7, 2001

(51) Int. Cl. B60P 1/64

(52) U.S. Cl. 414/500

(57) ABSTRACT

A cargo loading and unloading device for use with vehicles having a bed that is suitable for hauling cargo, for example, trucks, trailers. The device, which is configured to handle general or specific types of cargo, such as motorcycles, personal watercraft, and so forth, comprises a guide assembly that is mountable proximal to the opening that provides access to the bed of the vehicle. The guide assembly comprises a frame having a strap guide and at least one support guide mounted thereto. A movable carriage that is configured to hold the cargo is sized and configured to be at least partially receivable within and carried by the bed of the vehicle. A winch that is mountable to the vehicle proximal the end of the bed that is distal the open end of the bed is attached to one end of a connector, and the second end of the connector is attached to the carriage. Before the carriage is loaded into a vehicle, the connector extends from the winch over the connector guide and to the first end of the carriage. When the winch is rotated the first end of the carriage is lifted upwardly until the first end of the carriage engages and rides upon the support guide, and then the carriage is pulled over the support guide until the carriage is pulled into the vehicle.

### BACKGROUND OF THE INVENTION

1. Field of the Invention

The present invention generally relates to cargo handling apparatus, more particularly for loading cargo into, and unloading cargo from, a vehicle having a bed suitable for holding cargo.

2. Description of the Prior Art

The prior art discloses many systems used to assist in loading and unloading cargo from trucks and trailers. Many of these devices are designed for loading and unloading a particular type of cargo.

For example patents issued to Goss, deceased et al., U.S. Pat. No. 5,354,164 and Smith et al., U.S. Pat. No. 5,069,595 each disclose a mechanism for loading a boat onto a truck. The mechanism utilizes a frame that is mounted to a truck and when the frame is loaded with a boat it is pivoted so that the boat is held within the bed of the truck or is lifted above the truck bed so that the boat projects over the roof of the cab and the hood of the truck. A third patent, U.S. Pat. No. 4,212,580 issued to Fluck, comprises a trailer that is backed close to a body of water so that the boat may be pulled onto the trailer. The trailer is then pulled within the bed of the truck with portions of the trailer extending outwardly therefrom.

Several patents disclose ramps attached to frames that lie within the bed of the pickup. Patents to Schmoling, U.S. Pat. No. 5,810,546, and Beck, U.S. Pat. No. 5,934,863 each disclose winches pulling personal watercraft up ramps and into the beds of pickup trucks. A third patent issued to Heine, U.S. Pat. No. 5,556,249 also discloses a ramp, but in this case the cargo is placed on a movable sled which is pulled up the ramp and into the bed area of the pickup truck.

Each of the devices disclosed in the above mentioned patents, require complex and bulky framework that is mounted in the truck bed, and/or pivoting mechanisms or ramps to aid in movement of the cargo into the truck bed. Notwithstanding the existence of such prior art apparatus, it remains clear that there is a need for a cargo loading device that is simple to operate and comparatively simple in construction by elimination of the ramps and pivoting frames.

### SUMMARY OF THE INVENTION

The present invention relates to an apparatus for loading and unloading cargo from vehicles having a bed that is suitable for hauling cargo, for example, trucks, trailers and the like. The device is configured to load and unload general cargo and/or specific types of cargo, such as motorcycles, personal watercraft, and boats.

The device comprises a guide assembly that is mountable to a truck or trailer so that the guide assembly is proximal to the opening that provides access to the bed of the truck or trailer. The guide assembly comprises a frame having a strap guide and at least one support guide mounted thereto.

The device further comprises a movable carriage that is configured to hold general cargo or specific items, as mentioned above. The movable carriage is sized and configured to be at least partially receivable within and carried by the bed of a vehicle. The device further comprises a winch that is mountable to the vehicle proximal the end of the bed that is distal the open end of the bed, which is adjacent the guide assembly.

The first end of a connector is attached to the winch for winding about the drum of the winch and the second end of the connector is attached to the carriage. Before the carriage is loaded into a vehicle, the connector extends from the winch over the connector guide and then to the first end of the carriage.

When the winch is rotated the carriage moves toward the vehicle until the first end of the carriage is generally under the connector guide, at which time the first end of the carriage is lifted upwardly until the first end of the carriage engages and then rides upon the support guide. As the winch continues to rotate, the carriage is pulled over the support guide until the carriage is as far into the bed of the truck as possible. The invention accordingly comprises an article of manufacturer possessing the features, properties, and the relation of elements which will be exemplified in the article hereinafter described, and the scope of the invention will be indicated in the claims.

### BRIEF DESCRIPTION OF THE DRAWINGS

For a fuller understanding of the nature and objects of the invention, reference should be had to the following detailed description taken in connection with the accompanying drawings, in which:

FIG. 1 is an isometric view of the cargo loading and unloading device of this invention;

FIG. 2 is a front elevational view of the guide assembly of the device of FIG. 1;

FIG. 3 is a top plan view of the guide assembly of FIG. 4;

FIG. 4 is a left side elevational view of the guide assembly of the device of FIG. 1, illustrating the attachment of the guide assembly to a trailer hitch;

FIG. 5 is a detailed isometric view of a portion of the first end of the carriage, illustrating the attachment of the second end of the connector to the carriage;

FIG. 6 is a detailed isometric view of the winch of this invention illustrating fthe means for attachment to a vehicle;

FIG. 7 is a top plan view of the carriage of the invention of FIG. 1;

FIG. 8 is a front elevational view of the carriage of FIG. 7;

FIG. 9 is a left side elevational view of the invention of FIG. 1, illustrating the attachment of the device to a vehicle shown in phantom and illustrating a motorcycle shown in phantom loaded on the carriage;

FIG. 10 is a left side elevational view of the device of FIG. 1, illustrating the device loaded within the bed of a truck, the truck being shown in phantom;

FIG. 11 is a left side elevational view of the device of FIG. 1 illustrating the carriage engaging the support guide as the carriage is lifted;

FIG. 12 is a left side elevational view of the device of FIG. 1, illustrating the carriage being pulled into the bed of the vehicle;

FIG. 13 is a top plan view of the carriage of the device of FIG. 1, illustrating the carriage being fully loaded into the bed of a vehicle; and

FIG. 14 is a left side elevational view of the device of FIG. 1, illustrating its use to load a personal watercraft into the bed of a vehicle.

Similar reference characters refer to similar parts throughout the several views of the drawings.

### DESCRIPTION OF A PREFERRED EMBODIMENT

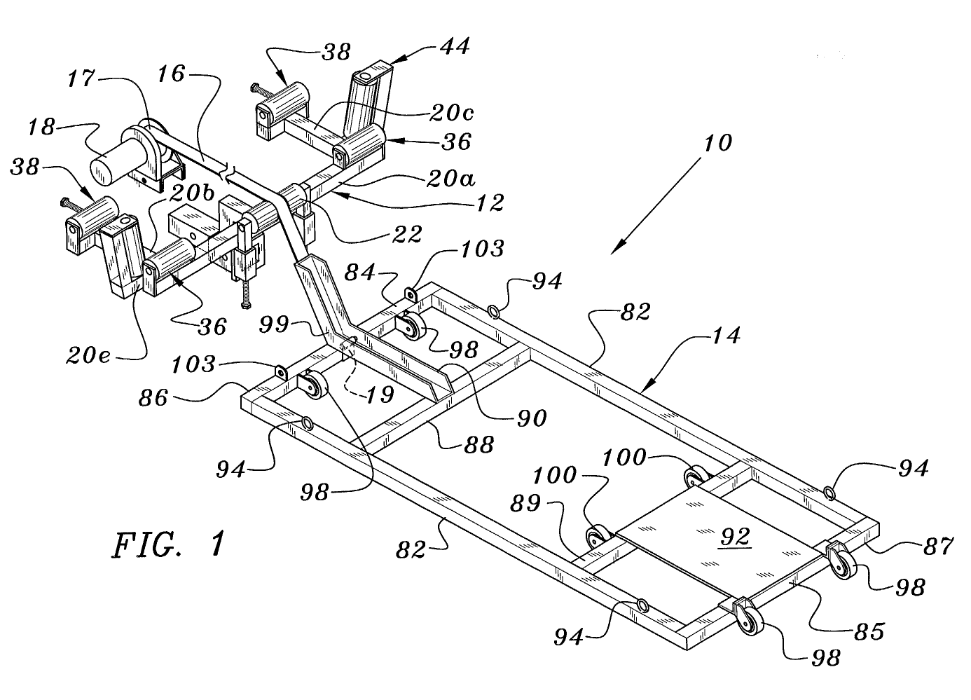

A preferred embodiment for the cargo loading and unloading device of this invention is illustrated in the drawing FIGS. 1-14 in which the device is generally indicated as 10. Referring first to the view of FIG. 1, it can be seen that the device 10 comprises a guide assembly, shown generally as 12, a carriage shown generally as 14, a winch 18 and a connector 16 having a first end 17 attached to the winch 18 and a second end 19 attached to the carriage 14

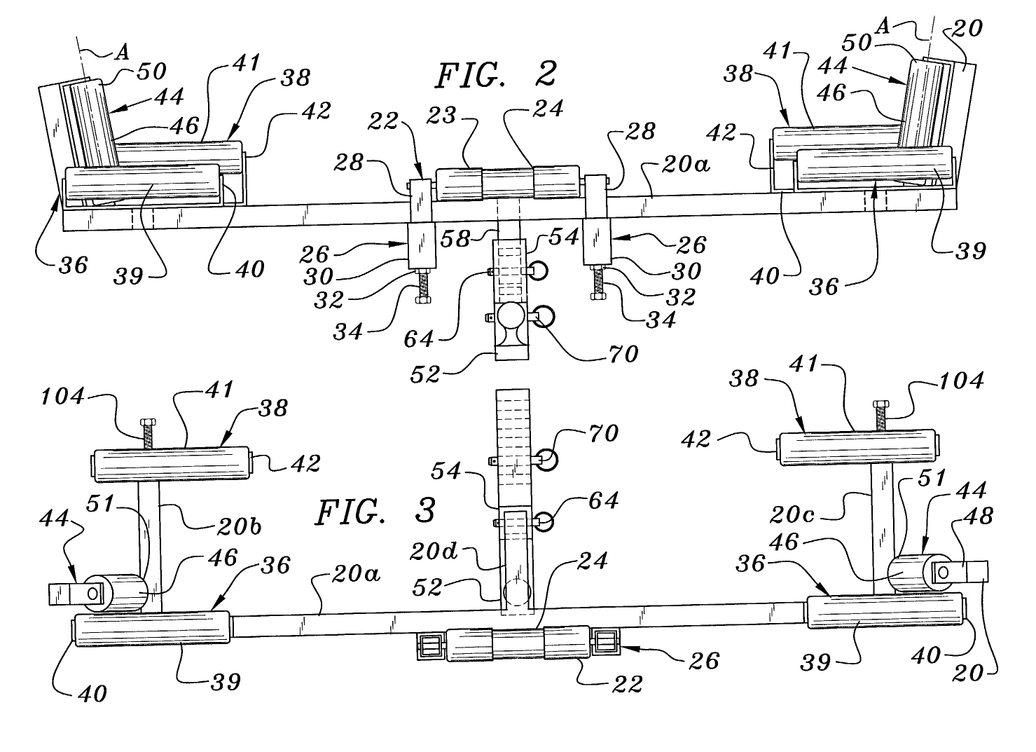

The guide assembly 12, as seen in FIG. 2 and FIG. 3, comprises a frame, composed of parts 20a-e, to which are attached a connector guide 22 and at least one support guide 36. In a preferred embodiment the connector guide 22 may comprise a stationary surface (not shown) over which the connector passes. With the use of low friction materials or lubricants on this surface, this would be satisfactory; however, in the preferred embodiment illustrated in FIGS. 1-3, the connector guide 22 comprises a roller 23 which reduces the friction and wear on the connector 16 and reduces the load on the winch 18. In a preferred embodiment, the connector 16, conveniently comprises a strap, as shown in the drawing figures. In FIGS. 2 and 3, it can be seen that the roller 23 has a circumferential recess 24 formed therein that is just wider than the width of the strap to keep the strap centered on the roller 23 and to help prevent the strap from disengaging therefrom. In other preferred embodiments, the connector 16 may comprise a cable, and then the recess 24 would be structured as a V-groove, for retention of the cable, rather than the wide recess necessary for retention of the strap. The strap or cable is preferably constructed from woven strands of nylon; however, other synthetics, steel wire, hemp or any other material that is suitable for the purpose may be used.

As seen in FIG. 2, the strap guide 22 is attached to frame part 20a by a pair of adjustable posts 26. Each post is comprised of an element 28 and a sleeve 30. The sleeve 30 is attached to the frame while the roller 23 is attached to the element 28. The element is movable within the sleeve 30. A nut 32 is attached by welding, or other suitable means, to the bottom of the sleeve 30 and a bolt 34 is threadably inserted through the nut 32 and a hole (not shown) in the bottom of the sleeve 30. The first end of each bolt 34 (not seen) engages the bottom of a respective element 28 (not shown) so that the elements, and thus the roller 23, can be raised or lowered by rotation of the bolts 34.

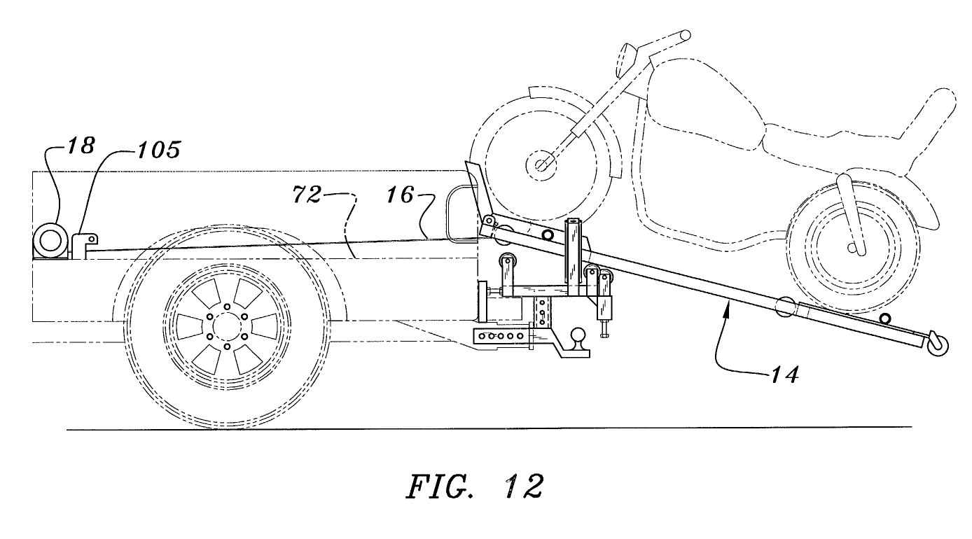

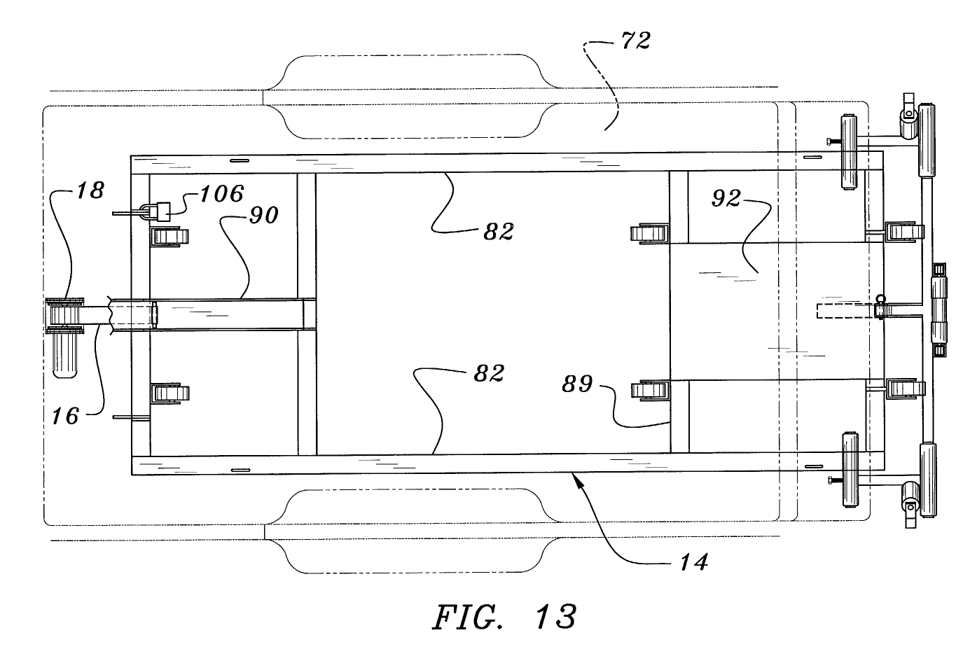

At least one support guide is connected to the frame part 20a for support of the carriage 14 as shown in FIG. 12. In a preferred embodiment, a support guide 36 is attached at each of the opposing ends of the frame part 20a. In another preferred embodiment, a single support guide (not shown) may extend across the width of the guide assembly 12; which would incorporate the pair of spaced apart support guides 36, which are shown in FIG. 1. To reduce the cost and weight of the guide assembly 12, the pair of support guides 36 are preferred over a single support guide.

The guide assembly further comprises a second pair of support guides 38, one of the pair of support guides 38 being mounted to each of frame parts 20b and 20c, as shown in FIG. 3. In another preferred embodiment, a single support guide (not shown) may extend across the width of the guide assembly 12, thereby incorporating the pair of support guides 38. However, to reduce the cost and weight of the guide assembly 12, a pair of spaced apart support guides 38 are preferred. The second pair of support guides 38 are spaced apart from the first pair of support guides 36 so that the carriage 14 is received on support guides 36 and 38 and is thereby generally stabilized.

Each support guide of the pair of support guides 36 is comprised of a roller 39 and a bracket 40, and each support guide of the second pair of support guides 38, comprises a roller 41 and a bracket 42. The rollers 39 and 41 are mounted in their respective brackets 40 and 42 for attachment to the frame 20. The brackets may be welded or bolted to the frame 20 or attached to the frame by any other suitable means. As can be seen in FIG. 3, one of the pair of brackets 42 is attached to a rearwardly extending frame part 20b and the other one of the pair of brackets 42 is mounted to rearwardly extending frame part 20c, so that the guides 36 and 38, that are mounted proximal to the same ends of the frame 20a, are spaced apart from one another. In one preferred embodiment the axis of the rollers 39 and 41 lie in the same plane, but in another preferred embodiment, as seen in FIG. 2, the brackets 42 are sized so the axes of the rollers 41 are horizontally positioned above the axes of the rollers 39. In another preferred embodiment, each support guide of the pair of support guides 36 and the second pair of support guides 38 may comprise a stationary plate covered with low friction material or a lubricant upon which the carriage may slide. However, rollers are preferred as they reduce the frictional resistance to the movement of the carriage 14 and reduce the load on the winch 18.

One of a pair of retaining guides 44 is mounted on each of the frame parts 20e, and a corresponding frame part (not shown) that is attached to frame part 20c. The retaining guides 44 keep the carriage longitudinally aligned with the sides of the vehicle and with the pairs of support guides 36 and 38. These retaining guides 44 may also comprise stationary plates or shafts that are coated with a low friction material or a lubricant; however, rollers 46 are preferred. Each roller 46 is rotatably mounted to a bracket 48, one roller 46 being attached to the frame part 20e which is attached to frame part 20b and the second roller 46 is mounted to a portion of the frame (not shown) which is attached to the frame part 20c. Both rollers 46 are connected to the frame 20a-e so that they are proximal, but spaced apart from an adjacent support guide 36. The retaining guides 44, and thus the rollers 46, are connected to the frame 20b and 20c so that they are spaced apart from one another a distance greater than the width of the carriage 14. In a preferred embodiment, the axes A of the rollers 46 lie in the same plane and the axes A of the rollers are angled so that their first ends 50 are spaced apart from one another further than the second ends 51 are spaced apart from one another, to more readily receive the longitudinal members 82 of the carriage 14 therebetween, particularly if the carriage is misaligned with the sides of the vehicle. In other preferred embodiments, the roller axes A may be at differing distances from the frame part 20a, as it is preferred but not essential that the roller axes A lie generally in the same plane.

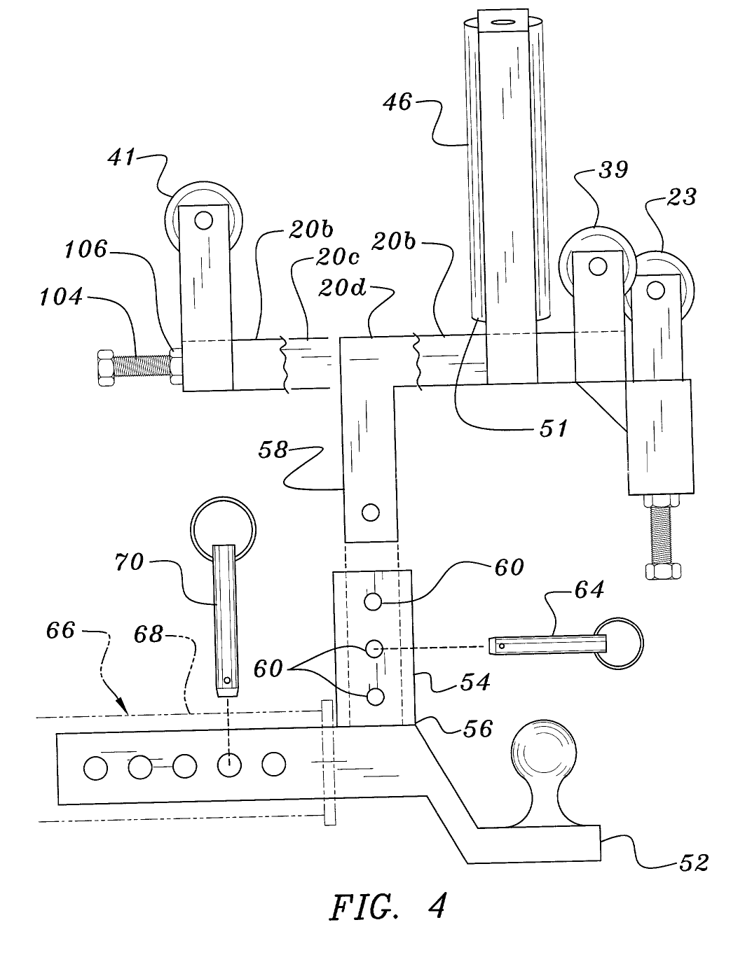

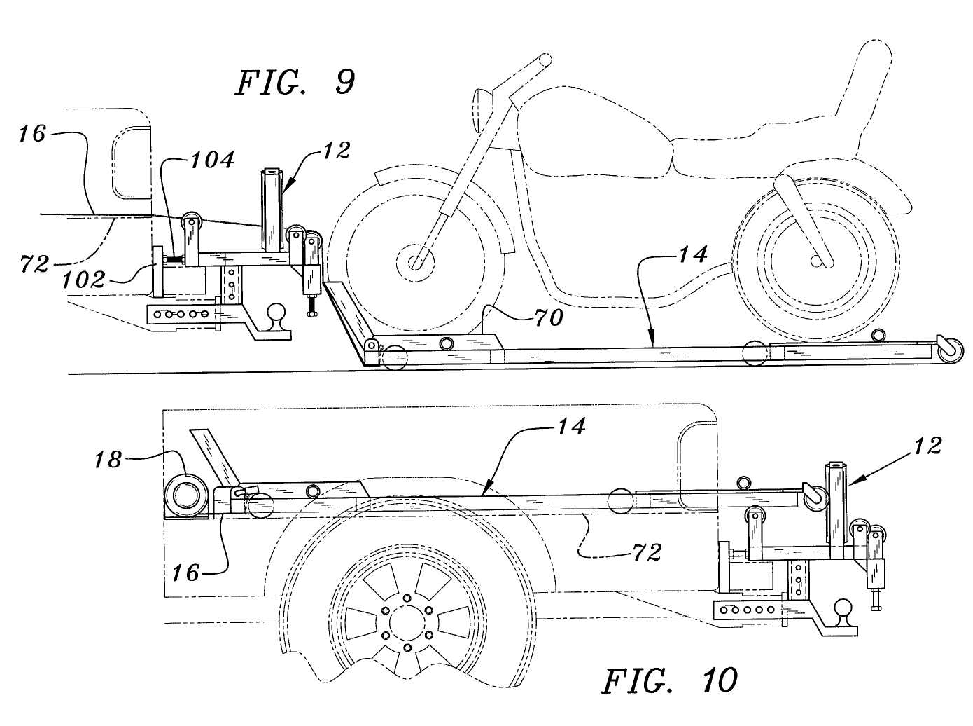

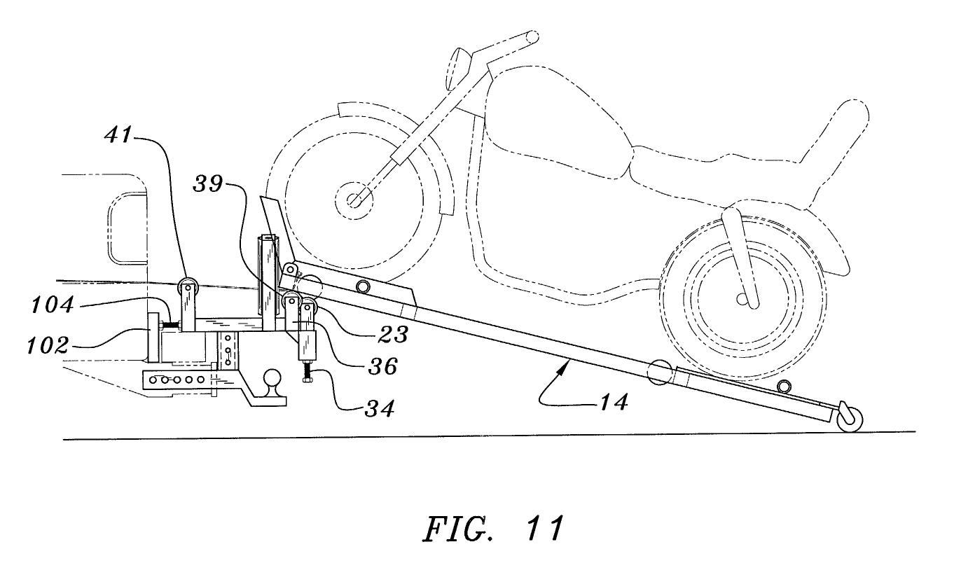

The particular placement of the rollers in relationship to one another is important to the overall functionality of the device 10. As seen in FIG. 4 and in FIG. 9, the roller 23 is lower than roller 39, which in turn is lower than roller 41. It is important that the top surface of the roller 41 be approximately one-fourth to one-half inch above the bed of the vehicle so that the carriage 14 does not strike or rub against the open end of the bed. It is important that the roller 39 be approximately one-half inch below roller 41 to assist in the unloading of the carriage by gravity. It is important that the roller 23 be slightly lower than roller 39 so that the front end of the carriage 14 will engage the upper half of the roller 39, permitting the roller 39 to rotate under pressure from the first end of cross member 84. This will permit the roller 39 to rotate so that the longitudinal members 82 ride up on top of the rollers 39, permitting the carriage to advance. If the roller 23 is low enough that the first end of cross member 84 engages the lower half of roller 23 the front of the carriage will engage the roller 39, but will not advance. If the roller 23 is higher than roller 39, the cross members of the carriage will engage the roller 23 as the carriage advances and either ride over the roller 23 or hang up on it preventing the carriage from advancing. The roller 23 must be slightly in front of roller 39, otherwise the carriage will again engage roller 39 and fail to advance.

The rollers used for the connector guide 22, the pair of support guides 36 and 38, and the retaining guides 44, are constructed from steel tubes mounted on a shaft (not shown) for rotation, with roller bearings (not shown) mounted therebetween to reduce the rotational friction. Such rollers are well-known to those skilled in the art, and they may be constructed from other materials that are suitable for the purpose.

The guide assembly 12 is attachable to a vehicle, usually a pickup truck, trailer or the like, proximal the open end of the vehicle's bed and thus proximal the rear bumper. Those skilled in the art will be able to fashion many different methods for attachment of the guide assembly 12 to a vehicle, including plates (not shown) attached to the guide assembly that are bolted or welded to a vehicle. In a preferred embodiment, a rearwardly extending frame part 20d has a downwardly extending peg 58 attached thereto. The peg 58 may be received in a hollow post attached to the bumper or the frame of the vehicle. In a preferred embodiment, the guide assembly 12 is designed to be removably attachable to the draw bar 52 of a standard trailer hitch. As seen in FIG. 4, in another preferred embodiment, the draw bar 52 is modified by welding a hollow post 54 to the top surface 56 of the draw bar 52 that is sized and configured to receive the peg 58 therein. The hollow post 54 has a plurality of holes 60 therethrough and the peg 58 has a hole 62 therethrough so that the peg 58 may be adjustably attached to the post 54 by a pin 64. Pin 64 is passed through one of the holes 60 when it is lined up with hole 62. It is also preferable that the hitch 56 be adjustable so that the draw bar 52 is adjustably received within the receiver 68 and held in position by a pin 70. This adjustability will assist in properly mounting the guide assembly 12 so that it is spaced apart from the vehicle.

The winch 18 is removably attached to the bed 72 of the vehicle proximal the closed end of the bed, as seen in FIG. 10. Those skilled in the art will be able to design many methods for attachment of the winch to the vehicle, one preferred embodiment comprising a pair of flanges 74 that are spaced apart from one another and welded to the bed 72 of the vehicle, as seen in FIG. 6. The winch 18 is attached, preferably by welding, to a channel 76 which is received between the flanges 74. A pin 80 is insertable through a series of holes that are aligned with one another and extend through the flanges 74 and the channel 76. It is preferable that the pin have a hole therethrough to receive a lock 78 to reduce the risk of theft of the winch 18. In the preferred embodiment illustrated in FIG. 6, the winch 18 is an electric winch operating off the battery of the vehicle. In other embodiments, the winch may be a geared hand winch, which would dictate attachment to the vehicle at a more accessible location. With the hand winch located at a higher location to make it more accessible for rotation of the winch crank, it is necessary for a pulley, or other means, to redirect the connector from proximal the bed 72, as seen in FIG. 9 and FIG. 12, upwardly adjacent to the closed end of the bed to the hand winch.

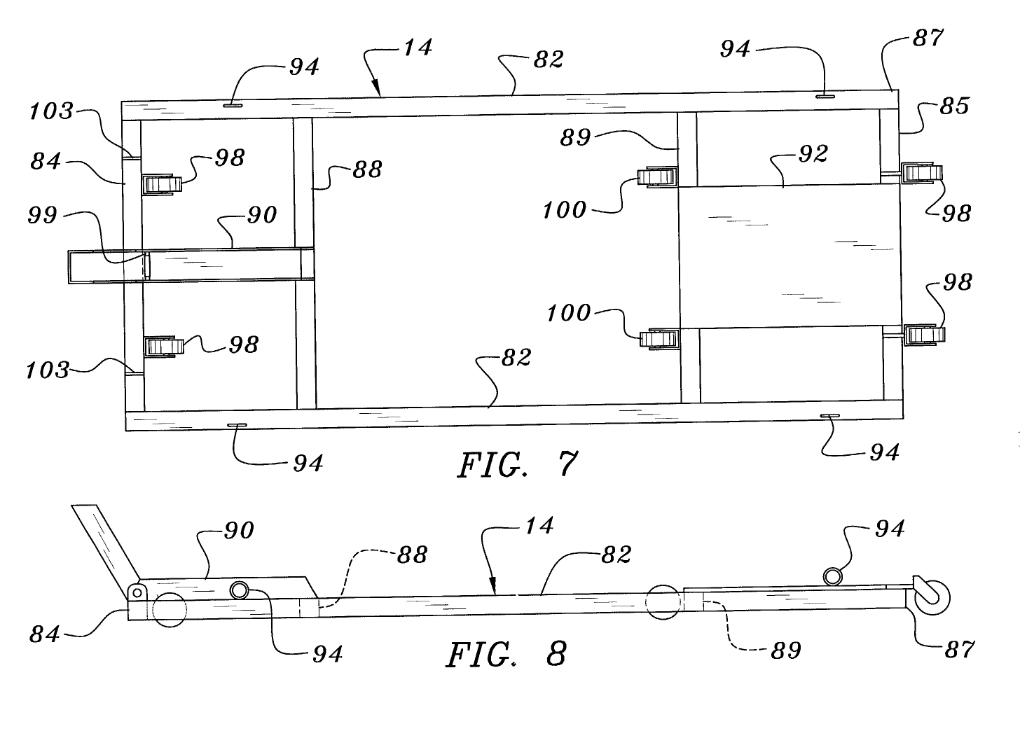

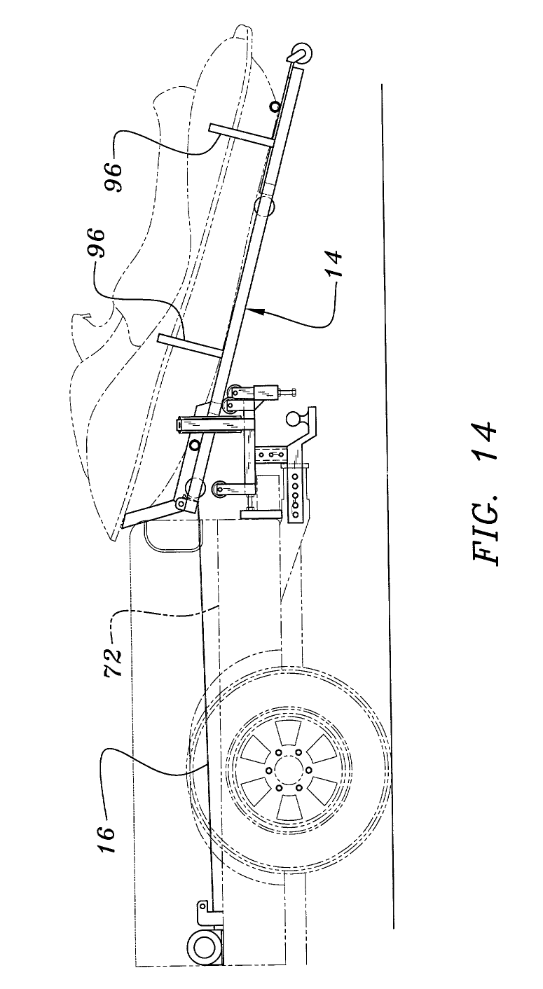

As seen in FIGS. 7 and 8, the carriage 14 comprises a framework of members, including two longitudinal members 82, and a first end cross member 84 and a second end cross member 85 extending therebetween. The carriage has a first end 86 and a second end 88. Interior cross members 88 and 89 are provided to structurally strengthen the carriage and to support additional structure that is designed to transport specific cargo. The carriage illustrated in FIG. 1 is particularly designed to support a motorcycle, the carriage having an L-shaped channel 90 that is attached to the first end cross member 84 and is attached to the first interior cross member 88. The carriage also has a platform 92 that extends from the the second end cross member 85 of the carriage to the second interior cross member 89. The length of the carriage is sized and configured so that the front wheel of the motorcycle is inserted within the L-shaped channel 90 and the rear wheel rests on the platform 92. Rings 94 are spaced along the longitudinal members 82 to provide a means for tying down the motorcycle. In other embodiments, as shown in FIG. 14, the carriage may include arms 96 attached to the lateral members 82 to support a personal watercraft. In another preferred embodiment, the platform 92 may be enlarged to cover the entire framework (not shown) and upwardly extending sides attached to the longitudinal members 82 and end cross members 84 and 85 of the carriage (not shown) so that loose cargo can be retained on the carriage 14. A pair of wheels 98 are attached to the first end cross member 84 and a pair of wheels 98 are attached to the second end cross member 85 for ease of movement along the ground or pavement and on the vehicle bed. In other preferred embodiments, skids may be used in place of the wheels. A third pair of wheels 100 are attached to the cross member 84 that is proximal to the second end 87 of the carriage, so that if the carriage is placed in a vehicle having a short bed, as seen in FIG. 10, the third set of wheels 100 will engage the vehicle bed 72 supporting the carriage 14.

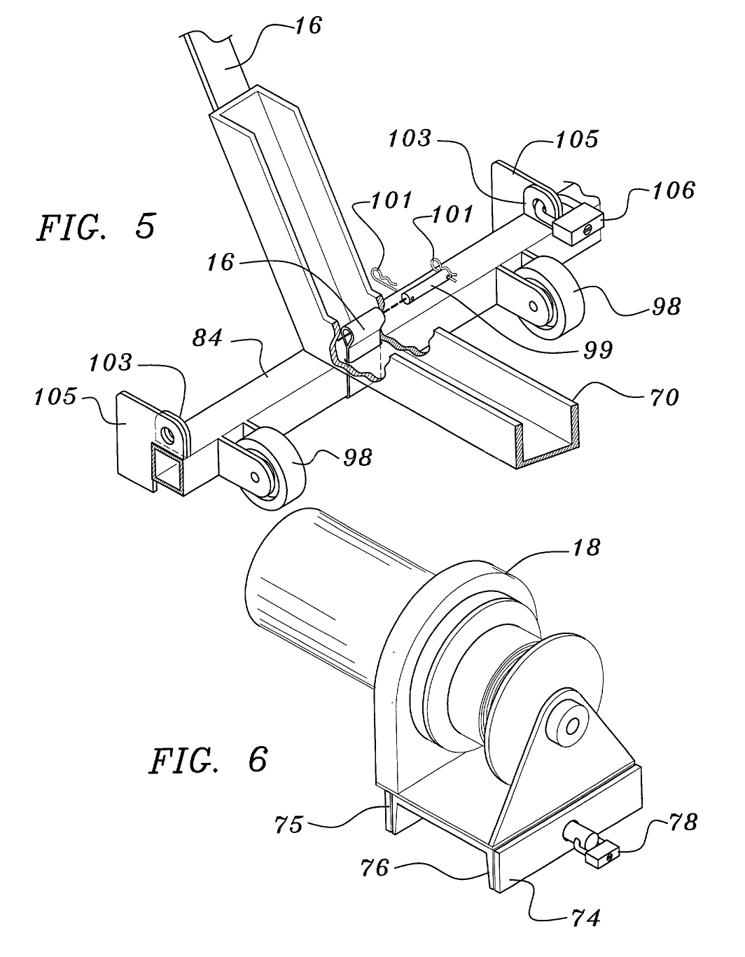

As seen in FIG. 5, a detail of the first end 86 of the carriage, the second end 19 of the connector 16, conveniently a strap, is formed into a loop through which is passed a pin 99 that is mounted to the L-shaped channel 90. For ease of operation it is important that the pulling force be applied to the carriage at as low a point as possible. This is why the second end 19 of the strap is passed about the bottom of the first end cross member 84 and attached to the L-shaped channel 90. The first end of the connector 16 is attached to the winch in the manner dictated by the particular model of the winch. Also disclosed in FIG. 5, are a pair of ears 103 that are welded to the first end cross member 84. A matching pair of ears 105, that are L-shaped, are welded to the bed 72 of the vehicle to act both as a stop, by engaging the first end 86 of the carriage, and as a means for locking the carriage to the vehicle. To lock the carriage to the vehicle, each ear of the pair of ears 105 must be located so that it is adjacent to a corresponding ear 103 and holes through the ears 103 and 105 must be aligned with one another. Once the carriage has reached the stop position and the ears are aligned, a lock may be passed through holes in adjacent ears.

In a preferred embodiment, the frame and the carriage are constructed from hollow generally square steel tubing. Most of the other parts, unless otherwise indicated, are also constructed from steel. Depending on the planned use, other suitable lighter materials may be used with a satisfactory result. Those skilled in the art will be able to determine the strength of the steel or other materials to be used to fabricated the device 10, based upon the load that the device will carry. Those skilled in the art will also be able to determine the necessary power of the winch 18 and the strength of the connector, to ensure that they are suitable for the planned purpose.

Attention is now invited to a description of the use of the device 10. There are many vehicles that may use the device 10 to load and unload cargo, including trucks and trailers. The device 10 illustrated in the drawing FIGS. 1-14, is particularly adapted for use with a pickup truck having a relatively short bed 72. It would be obvious to those skilled in the art to modify the device 10 as necessary to fit other sized trucks and trailers and to support other loads. For convenience, the use of the device 10 will be described in terms of loading a motorcycle into a pickup truck; however, the same general steps would apply to a trailer or other style truck.

To use the preferred embodiment with a pickup truck, as shown in the drawings, here are a number of minor modifications that must be made to a pickup truck to use the referred embodiment of the device 10 illustrated in the drawings. First, the tailgate must e removed; second, a winch 18 must be installed in the center of the bed proximal the cab; third, a trailer hitch must be mounted on the truck; and fourth, that hitch must be modified by mounting the hollow post 54 to the draw bar 52.

The guide assembly 12 is then mounted to the truck by asserting the peg 58 into the hollow post 54 and securely attaching the peg to the post with pin 64. After mounting the guide assembly 12 minor adjustments may be necessary to ensure that the top edges of the rollers 41 lie approximately one-half inch above the bed 72 of the truck. After adjusting the height of the guide assembly, the guide assembly may be stabilized by inserting a piece of wood 102 between the rear of the pickup and the bolts 104. As seen in FIGS. 3 and 4, the bolts 104 are threadably inserted into nuts 106 that are welded to the frame 20b and 20c. Holes are bored through the ends of the frame 20b and 20c along the axis of the bolts so that the bolts may be threaded inwardly as far as necessary. To stabilize the guide assembly 12, the bolts 104 are extended outwardly until they engage the piece of wood 102, as seen in FIG. 9. The wood is inserted between the bolts and the truck to protect the finish of the truck. Obviously, other pieces of material may be used in place of wood, such as rubber bumpers mounted over the ends of the bolts.

The carriage 14 is then position behind the truck so that is longitudinally aligned with the truck bed 72 and centered on the guide assembly 12. The winch 18 is operated in reverse until sufficient slack is obtained in the connector 16. The second end of the connector is then passed over the roller 23 and downwardly to the carriage on the ground, and the second end of the connector (formed in a loop) is then attached to the carriage by passing the pin 99 through the loop and attaching the pin to the carriage with retaining clips 101, as seen in FIG. 1 and FIG. 5.

A motorcycle may now be mounted on the carriage 14 as shown in FIG. 9. The winch 18 is then started, which pulls the carriage upwardly so that the carriage rides on the pair of wheels 98 that are mounted to the second end cross member 85. The first end 86 of the carriage rises until it engages the rollers 39 of the support guides 36, as seen in FIG. 11. If the first end cross member 84 engages the rollers 39 above the center axis of the rollers 39, the carriage will continue to advance on the rollers 39. If the first end cross member 84 engages the rollers 39 below the center axis of the rollers 39, the carriage will not advance, and an adjustment will need to be made in the height of the roller 23. The roller 23 will need to be raised by rotating the bolts 34 in a clockwise direction until the first end cross member 84 engages the rollers 39 above their center axis.

As the winch pulls the carriage 14 inwardly, in relation to the truck, the carriage 14 rides upwardly on the rollers 39 of the first pair of support guides 36, as shown in FIG. 12, and passes between the rollers 44 of the retaining guides 46, which keep the carriage aligned. As the carriage moves inwardly toward the winch 18, second end of the carriage 87 is lifted from the ground. As the carriage continues to advance, the weight of the carriage will cause it to pivot downwardly until the longitudinal members 82 of the carriage engage corresponding rollers 41 of the second pair of support guides 38, which will stabilize the carriage. As the carriage continues to advance into the truck, the first end 86 of the carriage pivots downwardly about the rollers 41 until the wheels attached to the first end cross member 84 engage the bed 72 of the truck. The carriage is advanced until the first end cross member 84 engages the ears 105, as seen in FIG. 13. The carriage may be locked in place by a lock 108 or a pin (not shown) by passing the lock or pin through the holes in the ears. This will prevent the carriage from rolling out the back of the open end of the truck, particularly while the truck as in operation.

To unload the carriage from the truck, the winch is operated in reverse to obtain enough slack in the connector 16 to allow the carriage to be pulled from the truck until it reaches its balance point on the roller 41. Once it has passed this pivot point, gravity will assist in the removal of the carriage from the truck. The winch will be used to slowly release the connector 16 against the pull of gravity on the carriage. Once the carriage is on the ground, the motorcycle may be removed and the carriage returned to the truck.

While the foregoing describes a particularly preferred embodiment of the present invention, it is to be understood that numerous variations and modifications of the structure will occur to those skilled in the art. Accordingly, the foregoing description is to be considered illustrative only of the principles of this invention and is not to be considered limitative thereof, the scope of the invention being determined solely by the claims appended hereto.

What is claimed is:

1. A cargo loading and unloading device comprising:
a guide assembly being mountable on a vehicle proximal an open end of the vehicle bed, said guide assembly comprising a frame, a connector guide attached to said frame, and at least one support guide attached to said frame;
a movable carriage for holding cargo, said carriage being sized and configured to be at least partially receivable by the bed of the vehicle;
a connector having first and second ends, said second end being attached to said carriage;
a winch being sized and configured so that it is attachable to the vehicle, said first end of said connector being attached to said winch so that said connector extends from said winch over said connector guide to said carriage prior to loading said carriage in the vehicle.

2. A cargo loading and unloading device as in claim 1, wherein said connector guide comprises a roller.

3. A cargo loading and unloading device as in claim 2, wherein said roller further comprises a circumferential recess formed therein for receipt of said connector thereby.

4. A cargo loading and unloading device as in claim 1, wherein said guide assembly comprises two support guides.

5. A cargo loading and unloading device as in claim 1, wherein said support guide comprises a roller.

6. A cargo loading and unloading device as in claim 1 wherein said guide assembly further comprises a pair of retaining guides mounted to said frame of said guide assembly, each of said retaining guides having a first end and a second end, said first ends of said retaining guides being spaced apart further from one another than said second ends of said retaining guides and said second ends of said retaining guides being spaced apart at a distance generally equal to or greater than the width of said carriage such that said carriage will pass therebetween.

7. A cargo loading and unloading device as in claim 6 wherein each said retaining guide comprises a roller.

8. A cargo loading and unloading device as in claim 1, wherein said guide assembly further comprises means for attachment of said guide assembly to a trailer hitch.

9. A cargo loading and unloading device as in claim 8, wherein said means for attachment of said guide assembly to a trailer hitch comprises a peg extending downwardly from said frame, said peg being sized and configured to be received by a hollow tube attachable to and extending upwardly from the draw bar of a trailer hitch, whereby said guide assembly is mounted to a vehicle when said draw bar is inserted in the receiver of a hitch mounted on a vehicle.
